(19) United States
(12) Patent Application Publication
(10) Pub. No.: US 2008/0104408 A1
(43) Pub. Date: May 1, 2008

(54) Notary document processing and storage system and methods

(76) Inventor: Darcy Mayer, Huntington Beach, CA (US)

Correspondence Address: YING CHEN;Chen Yoshimura LLP, 255 S. GRAND AVE., # 215, LOS ANGELES, CA, 90012, US

(21) Appl. No.: 11/586,118

(22) Filed: Oct. 25, 2006

(51) Int. Cl. H04L 9/00

(52) U.S. Cl. 713/178

(57) ABSTRACT

A notary document processing system and related methods are described. The notary document processing system receives files uploaded by users, processes them by applying a document ID, time stamp or other information to each page of the document, and converts them to read only format for storage. Once the document is processed and stored in the system, they cannot be edited or otherwise changed by any user including the owner of the document. The system makes stored documents available to the owner or other users upon the owner's request (document shared by owners) or permission (document requested by others). The users may also request others to verify the contents of documents. The system and method provide a way of preserving original versions of documents to be used later for purposes of evidencing the dates and contents of documents, evidencing agreement between parties as to the contents of documents, etc.

### BACKGROUND OF THE INVENTION

1. Field of the Invention

This invention relates to a notary document processing and storage system and related methods.

2. Description of the Related Art

Digital notary systems have been described and used in electronic commerce, and various processes and methods have been used in connection with such digital notary systems. For example, U.S. Patent Appl. Pub. No. 2004/0221162 describes a system that creates a document that has the appearance onscreen or in print of manually generated ones by creating an electronic seal, electronic dating stamp, electronic date, address, and signature. U.S. Pat. No. 6,904,416 describes a method and system that perform signature verification using third party authenticator via paperless electronic transaction platform. Other systems such as those described in U.S. Pat. Nos. 5,022,080, 5,781,629, and 6,587,945 provide various mechanisms for securely time stamping a document, verifying authenticity of electronic documents, or generally securing the electronic notary process. U.S. Pat. No. 5,136,646 describes a system in which the document is time stamped by creating a hash against the original and the server in which it is stored.

Document management systems have also been described and used. For example, U.S. Pat. No. 6,289,460 describes a system for allowing pre-designated users at remotely located computer-based systems to perform document management functions. Components of the system include a publication facility, a remote storage facility and a document manager computer-based system coupled to the computer-based systems used by the pre-designated users over a public data network. The system allows authorized users from remote locations to perform secure document collaboration, share and archive documents, context index documents, digitally notarize documents, electronically file documents and publish documents. (See Abstract.)

U.S. Pat. No. 7,035,830 describes a document filing method and system that has a user interface display connected to a server, the server being adapted to receive and display an electronic copy of a document submitted from a remote location for filing with the user of the server; an electronic stamping apparatus adapted to impart an electronic stamp on the submitted document responsive to a user input through the user interface; a database in electronic communication with the server and the user interface adapted to store the document after the electronic stamp is imparted to the document; and a communication device adapted to transmit an electronic copy of the document to the submitter with electronic stamp imparted to the electronic copy of the document. Authenticity of the electronic stamp is assured by storing the electronic document in a form that limits access and/or modification (see Abstract).

### SUMMARY OF THE INVENTION

The present invention is directed to a document engine for processing and archiving documents and making documents available to users.

An object of the present invention is to provide a system that allows users to preserve original versions of documents and to share them with others. Such documents may be used to provide documentary proof of the original content of a document as of the time of creation or upload as preserved by the system.

Another object of the present invention is to provide such a system that is easy to use and does not require special software on the users' computer.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a computer implemented method for processing and managing documents, which includes: receiving a document to be processed; generating document management information associated with the document, the document management information including at least a document ID; processing the document, including applying the document ID and a time stamp on each page of the document and converting the document to a read-only format; storing the processed document in association with the document management information; and retrieving the document based on the document management information.

In another aspect, the present invention provides a computer implemented method of managing documents, which includes: receiving a document to be processed; generating document management information associated with the document, the document management information including at least a document ID; storing the processed document in association with the document management information; at a request by a first user, generating a request to a second user to verify whether the content of the document is authentic; receiving a verification result from the second user; and storing the verification result and an identity of the second user in association with the document.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a block diagram of a notary document processing and storage system according to an embodiment of the present invention.

FIG. 2 illustrates the processing system and systems connected thereto in the notary document processing and storage system of FIG. 1.

FIG. 3 illustrates a requesting process performed by the requesting system of the notary document processing and storage system according to an embodiment of the present invention.

FIGS. 4(a)-(c) illustrate document referencing according to an embodiment of the present invention.

FIGS. 5(a)-(b) illustrates a verification process performed by verification system of the notary document processing and storage system according to an embodiment of the present invention.

FIG. 6 is an example of a document printed from the notary document processing and storage system of FIG. 1.

### DETAILED DESCRIPTION OF THE PREFERRED EMBODIMENTS

Embodiments of the present invention are directed to a notary document processing and storage system and related methods. The notary document processing and storage system receives files uploaded by users and converts them to read only documents that can never be edited, changed, altered, replaced, modified, revised, varied, tampered, manipulated, etc. by any user (including the user who uploaded them) once they have been successfully processed by the system. The system stores the user's documents on centralized and/or decentralized systems that the user can access via a public or private connection. The user may also share documents with others, or request others to verify the contents of documents. The system and method provide a way of preserving original versions of documents to be used later for purposes of evidencing the dates and contents of documents, evidencing agreements between parties as to the contents of documents, etc.

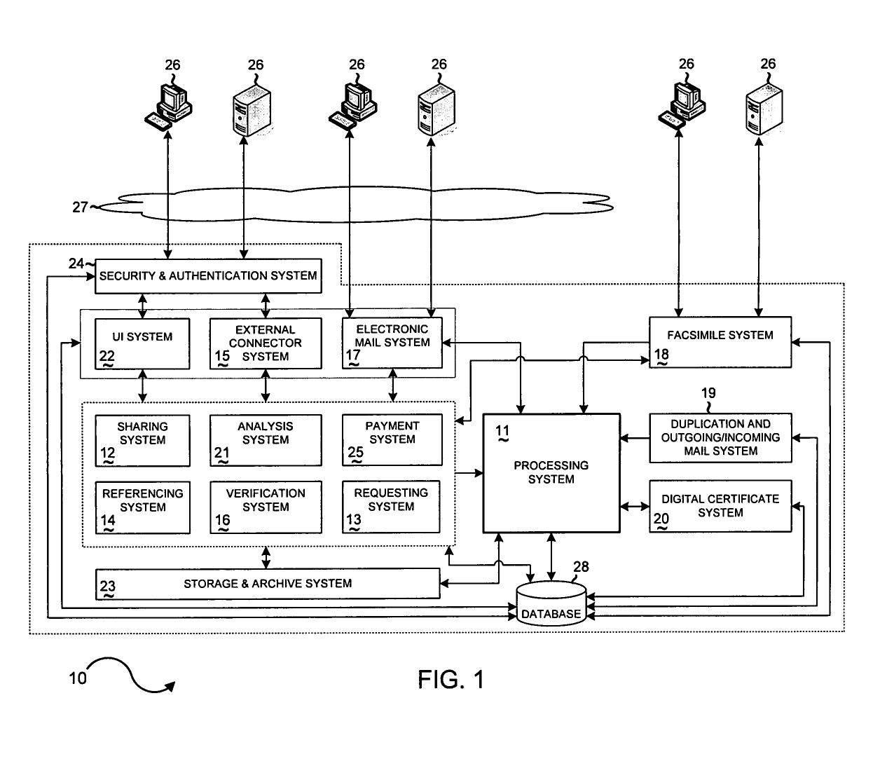

As illustrated in FIG. 1, the notary document processing and storage system 10 includes a security and authentication system 24 for authenticating users attempting to access the system, a UI system 22 for allowing users to interact with the system, an external connector system for uploading bulk or multiple documents into the system, an electronic mail system 17 for communicating with users by electronic mail or Short Message Service (SMS) messages, a facsimile system 18 for communicating with users via facsimile, a duplication and outgoing/incoming mail system 19 for handling hard copies of documents and notifications, a processing system 11 for processing the documents uploaded to the system, a storage and archive system 23 for storing documents, and a database 28 for storing information related to the documents. In addition, the system 10 also includes a sharing system 12, a referencing system 14, a verification system 16, a requesting system 13, an analysis system 21, a payment system 25, and a digital certificate system 20 that perform various document management and sharing functions of the system 10. These various components will be described in detail in turn.

As illustrated in FIG. 1, a plurality of users 26 are connected to the notary document processing and storage system 10 via a public and/or private network 27 or other communication systems such as facsimile lines. A user 26 is any user, which may be an individual or an organization such as a government agency, a public company, a private company, etc. Government agencies may include local, state, and federal agencies. Public and private companies may include industries such as medical, travel, legal, insurance, notaries, financial, business services, advertising, manufacturing, marketing, automotive, banking, real estate, sales, government, health care, retail, customer services, etc. In this disclosure, the term “user” 26 is also used to refer to a computer such as a personal computer, a server, etc. belonging to an individual or organization, and its meaning should be clear from the context.

A user 26 may submit documents to the notary document processing and storage system 10 using the UI system 22, the electronic mail system 17, the facsimile system 18, the duplication and outgoing/incoming mail system 19, the external connector system 15, or through any other suitable system that may forward and or send files to the processing system 11. These components, which will be described in more detail later, are referred to individually or collectively as the document intake system of the notary document processing and storage system 10.

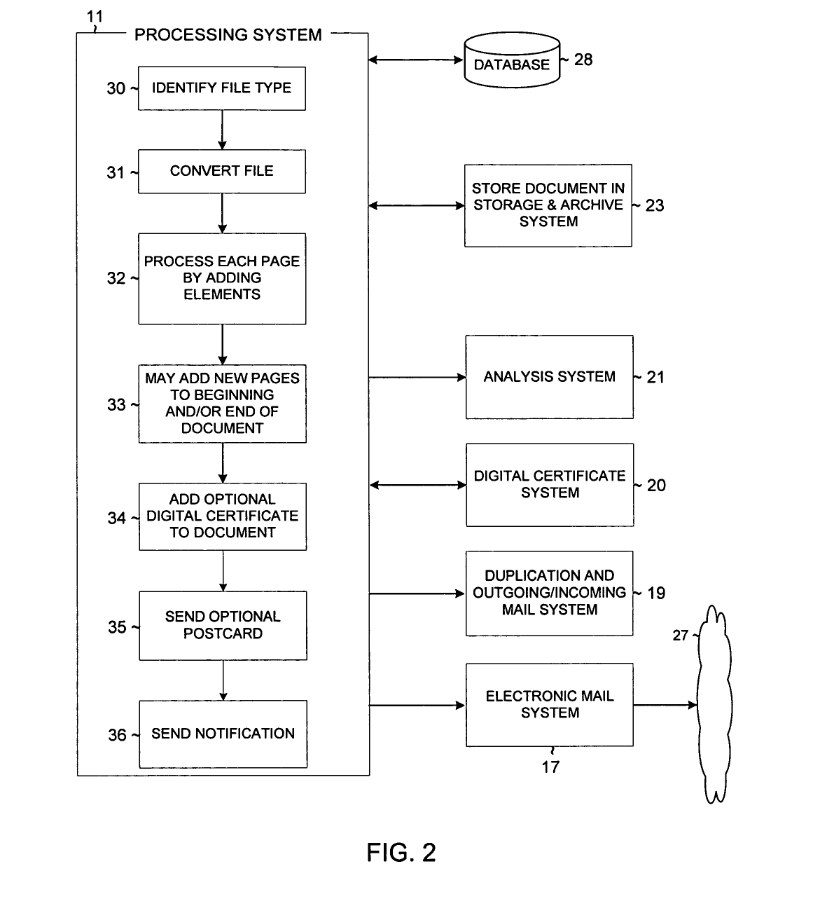

The processing system 11 is a unique system that can process many different types of file formats which may include file types such as documents and images, e.g. Microsoft™ Word documents, Joint Photographic Experts Group (JPEG) images, etc. into read-only formats. Once the processing system 11 has processed a file, the file cannot ever be edited, changed, altered, replaced, modified, revised, varied, tampered, manipulated, etc. by any users 26. As shown in FIG. 2, the processing system 11 first identifies the file type or file format of a received user file or files (step S30), and then convert the user file or files into read-only document formats such as an Adobe Portable Document Format (PDF), Tagged Image File (TIF), or other read-only formats including proprietary formats and formats that may be developed in the future (step S31), and store the files in the storage and archive system 23. The processing system 11 then retrieves document management information such as the document ID, document name, document creator, document creation date, etc. for each document from the database 28, and the corresponding file is also retrieved from the storage and archive system 23. The document management information has been previously stored in the database 28 when the document was entered into the system 10 via the document intake system as will be described in more detail later. The document ID is the unique identification number given to the file at the time the document was added through the document intake system such as the UI system 22 or the external connector system 15. The document ID is a unique identification number, which may be a Globally Unique Identifier (GUID), a randomly created alpha-numeric identification number, a randomly created alpha-numeric identification number with special characters, an alpha-numeric number generated by an algorithm, and/or an identification number created by any other suitable method of creating a unique number.

The processing system 11 processes each and every page of the document by adding elements to the page (step S32). This includes stamping or applying the document ID to each page. Here, “stamping” or “applying” (which may be used interchangeably in this context) means incorporating the document ID (or other relevant information) into the read-only document so that when the document is displayed or printed, the document ID (or other relevant information) is visible on the pages. Each page is also stamped with the date and time of when the document was created and/or uploaded through the document intake system. Each page of the document is also stamped with a bar code, such as one-dimensional bar code, two-dimensional bar code, color bar code, or combinations of these bar codes, or other types of bar codes that may be available. Documents may also have multiple bar codes on each page. Each page is also stamped with a page number. Other types of document management information may also be added to the document in step S32 such as the original file name at time of document creation, the Internet Protocol (IP) address of the user at the time of document creation, the document creator's name, etc. The processing system 11 may also add pages to the beginning and/or to the end of the document (Step S33). These added pages may have stamped on them the same information stamped on other pages. If the creator of the document is an authorized or licensed notary, that user's notary name, an image of the scanned notary's stamp, an image of the scanned notary's hand signature, an image of the scanned notary seal, address, notary license information, and/or other notary information may be applied to the beginning and/or end of the document, or to each page processed by the processing system 11. Each licensed or authorized notary will have filled out a form which contains their personal information, business information, license information, and provided a copy of their rubber stamp, a copy of their signature, and a copy of their notary seal if they have it. Once that notary has been deemed as valid by checking against various state and federal agencies, their information as well as scans of their rubber stamp, signature, address, license number, state licensed in, and seal are placed within the storage and archive system 23 and database 28. The processing system 11 may also stamps the terms and conditions, disclaimer, website information, etc. to the beginning and/or end of the document, or to each and every page processed by the processing system 11. The processing system 11 may also apply an optional digital certificate from an authorized digital certificate provider, Digital Signatures, digital fingerprints, etc. to the document (step S34). Digital certificates are sometimes licensed or issued from authorized digital certificate providers such as Verisign Inc, Thawte Inc, etc. Digital Certificates may also be created internally with certificate authority systems. A certificate authority is an authority in a network that issues and manages security credentials and public keys for document encryption and decryption. A digital signature (not to be confused with a digital certificate) is an electronic signature that can be used to authenticate the identity of the sender of a message or the signer of a document, and possibly to ensure that the original content of the message or document that has been sent is unchanged. Digital signatures are easily transportable, cannot be imitated by someone else, and can be automatically time-stamped. A digital fingerprint, also referred to as a hash, takes a long string of any length and produces a fixed length string as output through the use of an algorithm. The digital fingerprint would be unique to each document and cannot be imitated or reproduced by someone else. A digital certificate, digital signature, or digital fingerprint provides further proof of authenticity that the document was in fact processed by the processing system 11. A digital certificate, digital signature, or digital fingerprint, etc. can also protect against file tampering, and assure users or viewers of the document that the document is safe, as well as informing the user that the document truly came from the stated user, person, organization, etc., and that it hasn't been altered or corrupted.

Once a document is processed, it is transferred to the storage and archive system 23 where the processed documents are available to the user via the UI system 22 for review or download. The user may also opt to have an optional postcard sent to them by means of mail through the duplication and outgoing/incoming mail system 19 (step S35). The postcard may contain a bar code. The postcard may also contain the document ID associated with the processed document for identification, as well as other types of document management information mentioned earlier. The postcard may also contain other special codes, and may bear a radio frequency identification (RFID) tag. A RFID tag is an object that can be attached to or incorporated into an object such as the postcard for the purpose of identification using radio waves. The postcard, which is handled by the duplication and outgoing/incoming mail system 19, provides proof that the document was created at stated time by having it postmarked by the United States Post Service (USPS) or tracked by services such as Federal Express, United Parcel Service, DHL, etc. If there are any fees associated with the processing of files, they are processed by the payment system 25 as described in more detail later. Once the document is processed and finalized the document is written and/or copied to the storage and archive system 23, and the data associated with the document is written and/or updated in the database 28. The system may also send a notification to the user by electronic mail or SMS which is handled by the electronic mail system 17 that the document has been processed (step S36). SMS is the transmission of short text messages to and from a mobile phone, fax machine or IP address.

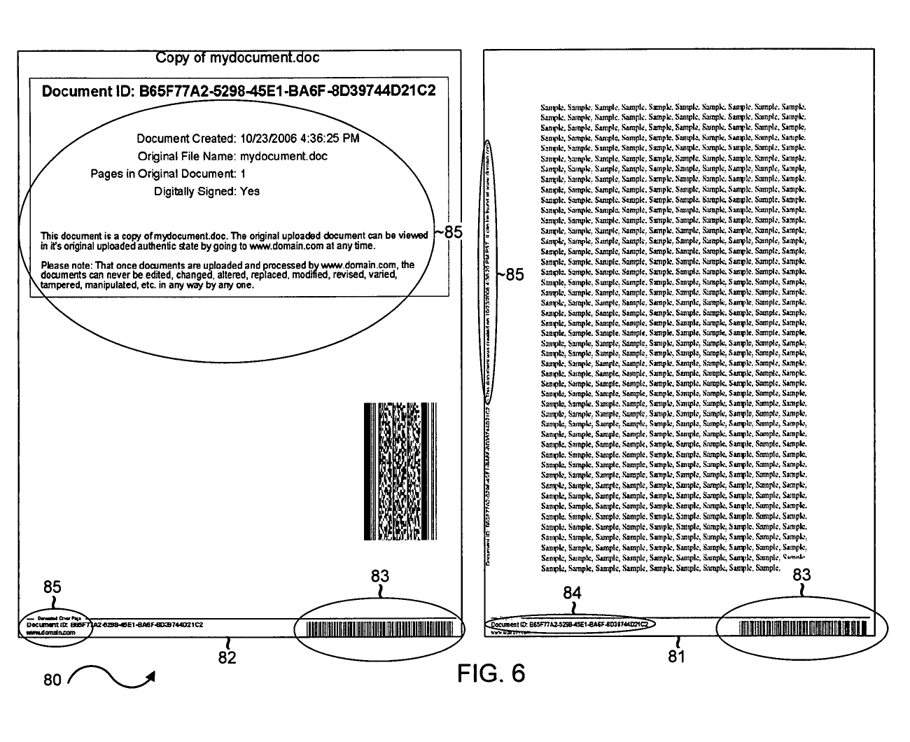

FIG. 6 shows an example of a document printed from the notary document processing and storage system 10. The document 80 contains one or more pages 81 corresponding the document received from a user, and a cover page 82. The cover page contains various document management information 85 such as document ID, creation date, etc. Each of the document pages 81 as well as the cover page 82 contains a barcode 83, document ID 84, and optionally other document management information 85 in a footer, a header and/or a side margin. For example, the website address of the provider of the notary document processing and storage system may be stamped on each page. It should be understood that the layout shown in FIG. 6 is by way of example only, and any other suitable arrangement of the stamped information can be used. It is preferable to stamp the information in areas not occupied by information of the user document.

The analysis system 21 is a system that works with other systems such as the UI system 22, the processing system 11, the verification system 16, the electronic mail system 17, the sharing system 12, the digital certificate system 20, the facsimile system 18, the duplication and outgoing/incoming mail system 19, the storage and archive system 23, the requesting system 13, the security and authentication system 24, the referencing system 14, the payment system 25, the database 28, external connector system 15, etc. that keeps tracking information such as document history, the last update date, the number of times shared documents were downloaded, whether the document has been verified, electronic mail notification logs, SMS notification logs, verification logs, share logs, request logs, facsimile logs, time/date logs of various systems, user logs, etc.

The digital certificate system 20 is a system that works with the processing system 11, the payment system 25, the database 28, the external connector system 15, etc. that manages or handles the certificates or digital certificates within the system. A digital certificate is an electronic “credit card” that establishes one's credentials when doing business or other transactions on the Web. It is usually issued by a certificate-issuing authority such as Verisign Inc, Thawte Inc, etc. The issued digital certificate contains the company's name, a serial number, expiration dates, a copy of the certificate holder's public key (used for encrypting and decrypting messages and digital signatures), and the digital signature of the certificate-issuing authority so that a recipient or user can verify that the certificate is real. The digital certificate system 20 adds certificates and/or digital certificates to documents for document authenticity, as well as tracking the certificates that have been, are in the process of, or have expired in the system.

The facsimile system 18 cooperates with the UI system 22, the analysis system 21, the storage and archive system 23, the database 28, and the payment system 25, which allows users to have their documents sent via facsimile to as many recipients as they want. A facsimile is a telecommunications technology used to transfer copies of documents, especially using affordable devices operating over the telephone network or through public or private networks. The facsimile system 18 tracks the status of each document sent to it through the analysis system 21. The facsimile system 18 can also handle incoming facsimile requests which allow users to add documents to their account via facsimile to be processed by the processing system 11 and made available to the user via the UI system 22. If there are fees associated with the incoming or outgoing facsimiles, they are processed through the payment system 25. The analysis system 21 logs the activities of the facsimile system 18.

The duplication and outgoing/incoming mail system 19 cooperates with UI system 22, external connector system 15, the database 28, etc., and allows users to purchase digital copies of their documents on storage media such as Compact Discs' (CD's), Digital Video Discs' (DVD's), floppy disks, etc. for a fee (processed through the payment system 25). Users can purchase postcards to be sent to themselves as described earlier or to other users. Items sent out through the duplication and outgoing/incoming mail system 19 are typically processed the following business day excluding any holidays and/or non-business days. Users can have hard copies of their documents made and sent to themselves or to other recipients specified by the users for a fee. Hard copies of documents may also have radio frequency identification (RFID) tags attached to or embedded in them. Hard copies of documents can be sent by any available method the user chooses using the UI system 22 or the external connector system 15, which may include the USPS, Federal Express, United Parcel Service (UPS), DHL, or any other ground or air service provider. The duplication and outgoing/incoming mail system 19 also performs a document intake function which allows for documents to be manually scanned and processed in the processing system 11 for users who are either unable to scan their own documents or would rather have it done for them for a fee. The analysis system 21 logs the activities of the duplication and outgoing/incoming mail system 19. The duplication and outgoing/incoming mail system 19 is preferably computer controlled, but typically requires manual handling of documents by operators for some of its functions.

The user interface system (UI) 22 consists of different layers. The layers are known as the presentation layer (user interface), the business logic layer (BLL), and the data access layer (DAL) which works with the database 28. The presentation layer is the layer that users 26 view on their systems using client-side applications, and/or custom applications such as Internet Explorer, Netscape, Opera, Firefox, etc. if they connect to the UI system 22 over a public or private network 27. Through the UI system 22, users 26 that are authenticated through the security and authentication system 24 can interact with the notary document processing and storage system 10, including to add new documents, edit documents, delete documents, view documents, verify documents, fax documents, electronic mail, share documents, request documents, reference documents, use the payment system 25, search documents, order copies of documents, etc. A user 26 that has successfully logged into the security and authentication system 24 through the UI system 22 or external connector system 15 is referred too as an authenticated user. When a user adds a new file through the UI system 22, a unique document ID is created, and the transaction is logged through the analysis system 21. The document ID is a unique identification number, which may be a Globally Unique Identifier (GUID), a randomly created alpha-numeric identification number, a randomly created alpha-numeric identification number with special characters, an alpha-numeric number generated by an algorithm, or an identification number created by any other suitable method of creating a unique number. The BLL connects the presentation layer to the DAL. The BLL allows for various applications to be run from within this layer as to not affect the users, and for security reason. The DAL is where the data from the UI is transferred to the database 28. The database or databases contains information such as user information, document information, file locations, certificate information, website information, application information from the BLL, etc. Pages within the UI system 22 display dashboards which provide the authenticated user with summaries. The UI system 22 allows an authenticated user to add new files to be processed by the processing system 11, edit the name, the description, category, etc. of an existing document; however, users will never be able to change, alter, or edit the processed document itself. An authenticated user can also view details about a processed document (document management information) such document ID, the document name, document creation date, document creator, document description, category, last updated date, number of pages in the document, original filename, document type, etc. Authenticated users can delete documents, create new document shares through the sharing system 12, request documents through the requesting system 13, create document references through the referencing system 14, search for documents owned by that authenticated user and documents being shared with that authenticated user, send documents by facsimile to anyone through the facsimile system 18, order copies of documents through the duplication and outgoing/incoming mail system 19, make payments and check account status though the payment system 25, etc. Authenticated users can also add digital certificates with the digital certificate system 20 at any time to processed documents if that option had not been chosen at the time of document creation. The analysis system 21 logs the activities of the UI system 22.

The storage and archive system 23 is a file repository and file archiving system that maintains all the processed documents, files sent as electronic mail attachments, facsimile data from the facsimile system 18, files that were uploaded, and/or added by authenticated users, etc. The storage and archive system 23 allows systems such as the processing system 11 to save processed documents as files onto either the local and/or remote storage. The UI system 22 also interacts with the storage and archive system 23 by allowing the user to add a new document where the original file is temporarily saved before it is processed by the processing system 11. The storage and archive system 23 also handles database transactions in relation to systems such as the processing system 11, facsimile system 18, duplication and outgoing/incoming mail system 19, electronic mail system 17, etc. The database 28 may store file information in the form of metadata as to its location in the local and/or remote storage locations. The database 28 may be either a local and/or remote system. The analysis system 21 logs the activities of the storage and archive system 23.

The security and authentication system 24 is the system that provides challenge/response security for the system that users use in order to be authenticated into systems such as the UI system 22, database 28, etc. There may be different types of authentication available to the users. They may consist of one-factor authentication where the user supplies a unique username and a unique password to be associated with that account. Two-factor authentication consists of one-factor authentication with a physical object the user possesses such as a small token card, a smart card, or other similar devices including those that may be developed in the future. The token card is a compact electronic device which displays a number or alphanumeric letters on a small screen. By entering this number into the system along with the unique username and password, the user proves that they are in possession of the card. The number displayed on the token card changes frequently typically at intervals such as 60 to 90 seconds. The security and authentication system 24 knows the number being displayed on the token card at the time it is entered. To increase security, the electronic device or token card is sometimes protected with a PIN. In this case, the user must enter the correct PIN before the correct numbers or alphanumeric numbers are displayed. A smart card is a card that resembles a credit card, but unlike a credit card each smart card has an embedded microprocessor. Each user must be in possession of his or her smart card and have a smart card reader. Once the user inserts their smart card into the card reader, the host computer and the card reader gains access to the microprocessor. The microprocessor then enforces access to the data on the card. Another device which may be implemented is a biometric device. A biometric device uses the user himself or herself as an authentication factor instead of a physical device utilized in traditional two-factor authentication. The biometric authentication measures and analyzes human physical and behavioral characteristics. For instance, physical characteristics may include fingerprints, eye retinas and iris patterns, facial patterns and hand measurements, while examples of mostly behavioral characteristics include signature, gait and typing patterns. Voice can be considered a mix of both physical and behavioral characteristics. For increased security the security and authentication system 24 may also utilize a three-factor security scheme. For added security, the security and authentication system 24 may also utilize a series of alpha-numeric numbers to be used with the one factor authentication such as a secret phrase, personal identification number (PIN), word, etc. that is only known by that user. The security and authentication system 24 is not limited to current technologies, and it is able to integrate with future authentication technologies as they become available.

The sharing system 12 allows an authenticated user who is the owner and/or creator of documents to share their documents through the UI system 22 or the external connector system 15 integrated with the database 28 with other members and non-members. A share is one-to-many, which means that a user is not limited by the number of members and non-members they want to share their processed document or documents with. A member is a user that has signed up, has at least a valid username and password, and can be successfully authenticated in the security and authentication system 24. A non-member is a user that has not signed up, does not have at least a valid username and password, and cannot be authenticated in the security and authentication system 24. A user that has been allowed a share must become a member in order to access a shared document. A member who is the owner and/or creator of the document can disable a share at any time using the UI system 22 or the external connector system 15. A member who is the owner and/or creator of the document can permit or allow shares at any time using the UI system 22 or the external connector system 15. A member must know some information about another member before he can share a document with the other member, such as the other member's electronic mail address, username, phone numbers, mobile numbers, etc. A member must know some information about a non-member before he can share a document with the non-member, such as the electronic mail address, facsimile number, physical address, phone number, mobile number, etc., of the non-member. Once a share is created, the other member or non-member (the recipient of the share) is notified by electronic mail or SMS through the electronic mail system 17, by mail through the duplication and outgoing/incoming mail system 19, or by facsimile through facsimile system 18, informing him that a share has been created by the authenticated user. The recipient may then attempt to access the document to view or download it, and the system will permit the recipient to do so. Members and non-members may also be notified once their share has been disabled or deleted by the authenticated user who initially allowed or permitted the access. An authenticated user cannot share a document that is not owned by him or was not created by him. Only a user that has created his own documents can share them.

The requesting system 13 allows any authenticated user or member, referred to as a requestor, through the UI system 22, the external connector system 15, etc. to request a document from another member who owns or created the document, as long as the requestor can provide information such as a document's document ID, the other member's name, the other member's username, the document create date, etc. The member that owns or created the document (the owner) is then notified through the electronic mail system 17 that there is a pending request waiting for him in the UI system 22. Once the owner has been authenticated in the security and authentication system 24, he can view the pending requests in the UI system 22 and may choose to allow or deny that request. In the event the owner chooses to allow the requestor to view the document, the requestor is notified by electronic mail or SMS through the electronic mail system 17 that his request has been allowed. At this point, once the requestor has been authenticated in the security and authentication system 24, he is allowed to view the requested document. Once a document has been allowed for viewing, it is automatically transferred into the sharing system 12. In the event the member who owns the document denies the request from the requester, the requestor is notified by electronic mail or SMS through the electronic mail system 17 that his request has been denied. In such a case, the requestor will not be able to view the requested document.

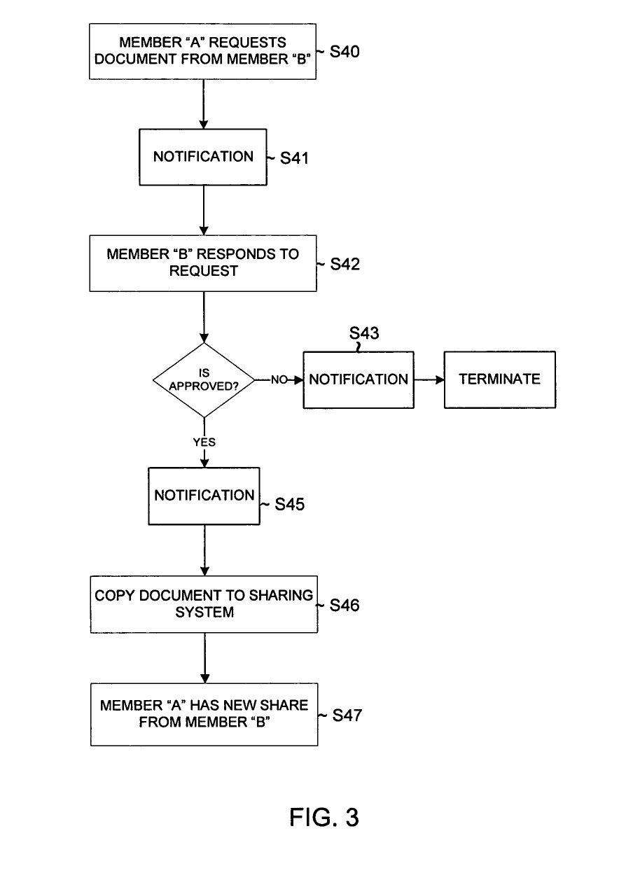

An exemplary process of the requesting system is illustrated in FIG. 3. As shown in FIG. 3, Member A requests to view a document from Member B (step S40) by providing information such as the document ID, Member B's name, Member B's username, the document creation date, etc. If the document is located, information such as the document name, creation date, document ID, description, etc. is displayed (but not the document itself), and Member A can choose to request viewing of the document. If Member A chooses to request the viewing of the document, Member B is notified by electronic mail and/or SMS (step S41) through the electronic mail system 17 that they have a pending request. All requests are also available through the UI system 22. Member B then responds to the request (step S42). If Member B allows Member A to view a document, an electronic mail or SMS notification is sent to Member A through the electronic mail system 17 (step S45), the document is copied to the sharing system 12 (step S46), and Member A is allowed to view the requested document (step S47). If Member B denies Member A's request to view the document, an electronic mail or SMS notification is sent to Member A (step S43), and Member B will not have access to the document. Authenticated users can also view their pending requests, allowed or permitted request, as well as their denied requests through the UI system 22.

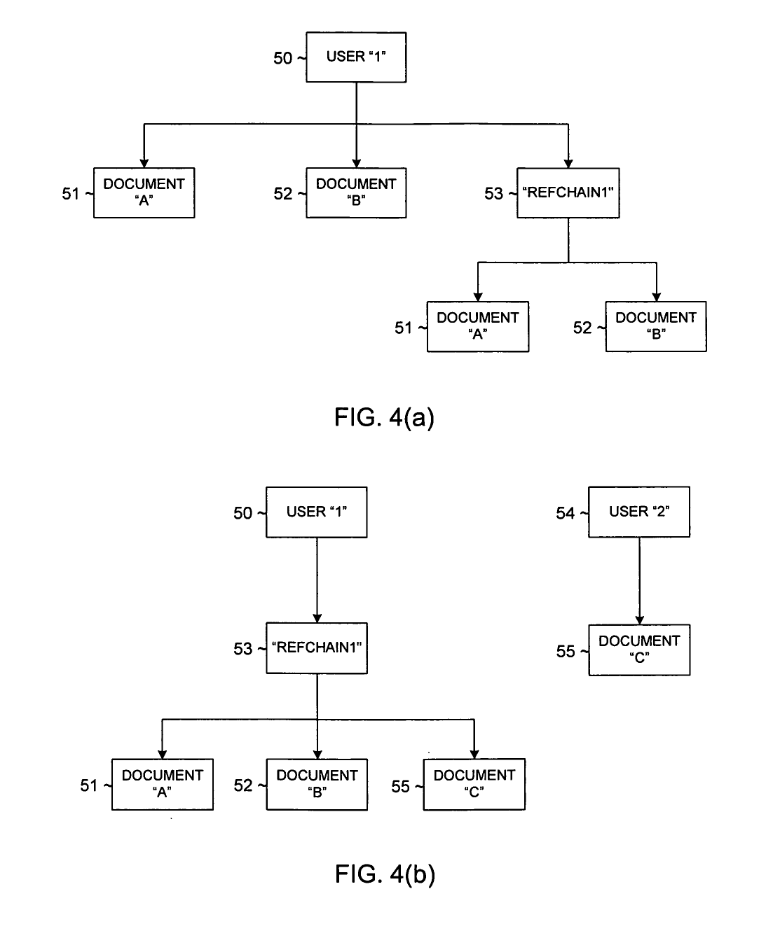

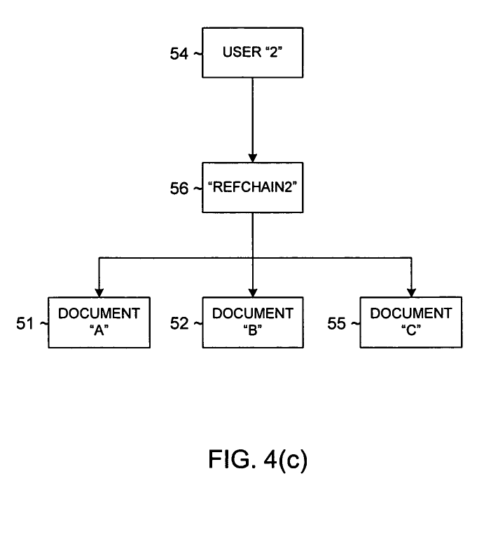

The referencing system 14 allows an authenticated user to create reference chains (also referred to as network chains) with documents that are currently owned by the authenticated user or documents that are being shared with that authenticated user, by using the UI system 22, external connector system 15, etc. The referencing system 14 cooperates with UI system 22, sharing system 12, database 28, external connector system 15, and storage and archive system 23. Through the referencing system 14, a user can create reference chains with document files deemed by the user to be related. For instance, as illustrated in FIG. 4(a), User “1” 50 owns or shares Document “A” 51 which is a contract and Document “B” 52 which is an addendum to Document A. User 1 deems these two files related, and connects both documents together by creating a reference chain “RefChain1” 53. If there are any documents being shared with the user through the sharing system 12 and if one or more of the documents being shared have any relation to the user, then that user can also reference any of those documents with new or existing references. Therefore, even though there is a reference chain, each document must have an allowed share before the authenticated user can view that document. In the next example illustrated in FIG. 4(b), User 1 also has a share by User “2” 54 called Document “C” 55, which is another addendum to Document A and an add-on to Document B. User 1 adds Document C to “RefChain1” 53. As illustrated in FIG. 4(c), by adding Document C to the reference chain, User 2 will also become aware of Document A and Document B; however, User 2 will not be able to view Document A or Document B until User 1 has granted permission for viewing rights. At this point, User 2 can send a new request to User 1 for viewing privileges of Document A and Document B.

The verification system 16 allows an authenticated user (a requester) to have another authenticated user (a verifier) verify a document as authentic by allowing the verifier to view a document in order to verify its content as authentic. The verification system 16 works with the UI system 22, database 28, and the sharing system 12. To accomplish this, the requester allows the verifier to view a document by creating a share. After the verifier has viewed or downloaded the document, the verifier can verify that content such as each page, signatures, dates, pages, images, text, titles, etc., have not been edited, changed, altered, replaced, modified, revised, varied, tampered, manipulated from an original agreed upon document. There can be more than one verifier verifying a document. Once the document has been verified, the verifier has the ability to approve the document as authentic to them by using the UI system 22. The verification system 16 is linked to the analysis system 21 where the verification of the documents is tracked and logged, so that the verifier cannot deny that they have verified the document. Such a verification function may be useful for documents such as contracts, trusts, agreements, other legal documents, copyrighted materials, etc. to evidence that parties have agreed to the content of a document stored in the notary document processing system as being authentic. Authenticated users can enforce the verification of documents. When the authenticated user enforces verification of a document, the other user (the verifier) is notified by electronic mail or SMS through the electronic mail system 17 at certain intervals for a period of time reminding him that he is being requested to verify said document until it is verified. If the verifier decides to verify the document, he can do it through the UI system 22 or external connector system 15. If the verifier determines that the document has been edited, changed, altered, replaced, modified, revised, varied, tampered, manipulated, etc., from an original document that the verifier has agreed upon, the verifier can create an event through the analysis system 21 where a record is created or logged, and the requestor is notified by electronic mail or SMS through the electronic mail system 17 that the verifier has determined that the document is not authentic.

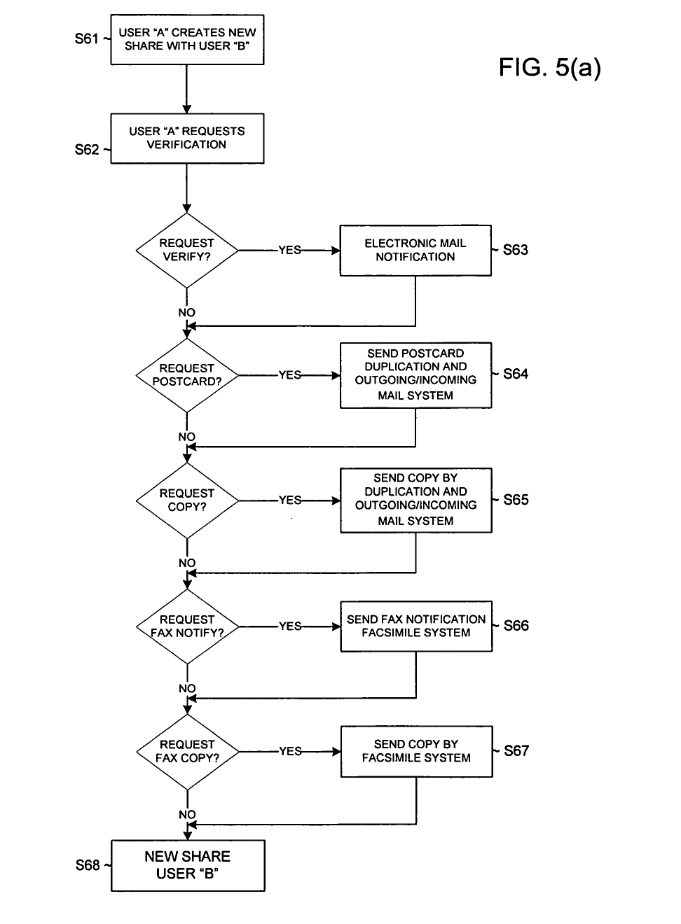

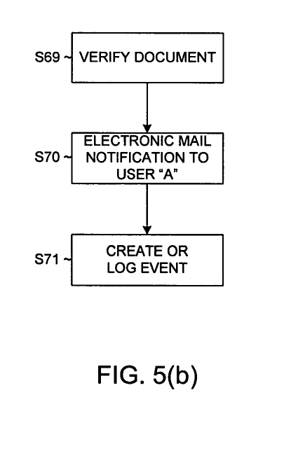

An exemplary process of the verification system is illustrated in FIG. 5(a). First, User “A” creates a new document share with User “B” (step S61). User “A” also requests that User B verify the document (step S62). An electronic mail or SMS notification is sent from the electronic mail system 17 informing User B of the new share and the request for verification from User A (step S63). User A also has the option of having postcards sent to users for documents they have created shares and are requesting verification on (step S64). The postcard may also contain the document ID associated with the processed document for identification as well as other types of document-related information such as the original file name at time of document creation, the Internet Protocol (IP) address of the user 26 at the time of document creation, the document creator's name, special codes, RFID, etc. The postcard may also contain a bar code. The postcard, which is handled by the duplication and outgoing/incoming mail system 19, provides proof that verification was requested at the stated date by having it postmarked by the United States Post Service (USPS) or tracked by services such as Federal Express, United Parcel Service, DHL, etc. User A may also have the option of having copies of documents sent to User B (step S65). Copies can be printed on regular or special types of paper such as watermarked paper making it more difficult to make unauthorized copies and/or forging copies. Outgoing postcards, and/or copies are handled by the duplication and outgoing/incoming mail system 19. If there are any fees associated with the processing of outgoing postcards or copies of documents, they are handled by The payment system 25. User A may also have the option of requesting facsimile notifications of verifications to be sent to User B (step S66), or requesting facsimile copies of documents sent to User B (step S67). The facsimile notification may also contain the document ID as well as other types of document-related information. The facsimile notification may also contain a bar code. All facsimile transactions are handled by the facsimile system 18. If there are any fees associated with the processing of facsimile notifications or copy or copies of documents, they are handled by The payment system 25. The analysis system 21 keeps track and logs the verification activity including the outgoing postcards or copies. A new share is created (step S68). After User B receives a postcard, facsimile of notification, or a copy of the document by mail or facsimile that he is requested to provide verification on, he uses the UI system 22 to complete the verification process. In the event User B is a non-member, he is required to become a member in order for the verification process to be complete.

As shown in FIG. 5(b), when performing verification, User B downloads or views User A's document, and confirms that the document is authenticate, i.e. unchanged, unaltered, and unedited from the document User A and User B originally created or agreed upon. User “B” then verifies the document through the UI system 22 or external connector system 15 (step S69). User A may receive an electronic mail or SMS notification through the electronic mail system 17 (step S70), and an event is created and logged through the analysis system 21 (step S71). The analysis system 21 also tracks and logs the number of times a shared document is downloaded. If User B determines that the document is not authentic (i.e. it has been altered, edited, etc.), User B can decline the verification and optionally provide a reason via the UI system 22 or the external connector system 15. An electronic mail or SMS notification may be sent through the electronic mail system 17 notifying User A that the verification has been declined. The analysis system 21 tracks and logs the event.

The electronic mail system 17 uses simple mail transfer protocol (SMTP), SMS Gateways, or any other application or protocol to send and receive notifications, electronic mail, SMS, and notifications from public and private networks 27. The electronic mail system 17 works with the processing system 11, the external connector system 15, the analysis system 21, the digital certificate system 20, the duplication and outgoing/incoming mail system 19, UI system 22, the storage and archive system 23, the security and authentication system 24, the sharing system 12, the requesting system 13, the referencing system 14, the verification system 16, the database 28, and the payment system 25. The electronic mail system 17 also has the ability to receive incoming electronic mail from members and non-members, parse out information such as the sender's electronic mail address, information from the electronic mail's subject line, information from the body of the electronic mail, any attachments associated with that electronic mail address, etc. If the incoming electronic mail is sent to a proper electronic mail address and has a valid electronic mail address from the sender of the electronic mail, with at least one valid attachment then the electronic mail system 17 parses out the sender's electronic mail address, and detaches any attached documents. The sender's electronic mail address is then entered into the database, and each attached document is placed into the storage and archive system 23 where it will stay in the queue until the processing system 11 accepts it to be processed. Once the document has been successfully processed by the processing system 11, the processed document is placed into the UI system 22, and the electronic mail system 17 notifies that user (the sender of the document) that the document has been successfully processed. If the user is a member, he will have instant access to the document if there are no fees due at the time. If the user is a non-member, he will not have instant access to the UI system 22 or his documents until he has become a member. Once a user becomes a valid member, and that authenticated user has used the same electronic mail address, he will be able to view and download any successfully processed documents as long as there are no fees due at the time within the UI system 22. The electronic mail system 17 can also handle outgoing as well as incoming SMS messaging.

The payment system 25 works with the processing system 11, the analysis system 21, the UI system 22, the facsimile system 18, the duplication and outgoing/incoming mail system 19, the electronic mail system 17, the external connector system 15, etc. The payment system 25 maintains charges that are currently due by a member, the member's current balance, the member's payment history, the members document charge history, etc. The payment system 25 may connect with online payment processing systems such as authorize.net, Pay Pal, etc. for external payment processing of credit cards through the public or private network 27.

The external connector system 15 is a system that allows users, from individuals, small business users to large enterprise users or any other type of user, to connect to the notary document processing and storage system 10 via public or private networks 27 with connections such as virtual private network (VPN), T-1 line, point to point, etc. to transmit bulk or multiple files at once as illustrated in FIG. 1. Users 26 may also be able utilize the notary document processing and storage system 10 through kiosks set up at various locations. A kiosk is an interactive system that is typically a touch-screen and computer placed in a secure enclosure in a public place that enables users to scan, add, upload, print, etc. new files, documents, or images directly into the system. Once a user has been established in the system it is very easy for him to transfer bulk files into the processing system 11 for processing using the external connector system 15. The users may need to install proprietary software, client side or server side software, or applications on their own systems in order to successfully connect over public or private networks 27, and must authenticate. Once authenticated into the system via the security and authentication system 24, users can transfer files into the processing system 11 for processing using the external connector system 15. The external connector system 15 works with the processing system 11, the verification system 16, the electronic mail system 17, the sharing system 12, the analysis system 21, the digital certificate system 20, the facsimile system 18, the duplication and outgoing/incoming mail system 19, the storage and archive system 23, the requesting system 13, the security and authentication system 24, the referencing system 14, the digital certificate system 20, the payment system 25, database 28, etc. A special kit may also be offered that may include proprietary applications or licensed applications, an imaging device such as a scanner, document feeder scanner, etc., signature scanning device, and/or a bio-metric device such as a fingerprint scanner, hand scanner, etc. that allows users such as notaries to securely notarize, and securely connect through public or private networks 27 to the external connector system 15. When files are added into the system through the external connector system 15, a unique document ID is issued to every file, its creation is automatically logged in the analysis system 21, and the document ID is written to the database 28.

It will be apparent to those skilled in the art that various modification and variations can be made in the notary document processing system of the present invention without departing from the spirit or scope of the invention. Thus, it is intended that the present invention cover modifications and variations that come within the scope of the appended claims and their equivalents.

1. A computer implemented method for processing and managing documents, comprising:
receiving a document to be processed, the document including one or more pages;
generating document management information associated with the document, the document management information including at least a document ID;
processing the document, including applying the document ID and a time stamp on at least some of the one or more pages of the document and converting the document to a read-only format;
storing the processed document in association with the document management information; and
retrieving the document based on the document management information.

2. The method of claim 1, wherein the processing step further includes applying a barcode on each page of the document.

3. The method of claim 1, wherein the processing step further includes applying a page number on each page of the document.

4. The method of claim 1, wherein the processing step further includes adding one or more pages at a beginning or end of the document, and applying the document ID and the time stamp on each of the added pages.

5. The method of claim 1, wherein the processing step further includes applying a digital certificate, digital signature or digital fingerprint to the document.

6. The method of claim 1, further comprising defining a reference chain linking the document with another stored document,

7. The method of claim 1, wherein the retrieving step is performed at a request or upon the permission of an owner of the document.

8. The method of claim 7, wherein the retrieving step comprises:
receiving from the owner information identifying a recipient of the document;
notifying the recipient of a document share created by the owner; and
retrieving the document for access by the recipient.

9. The method of claim 7, wherein the retrieving step comprises:
receiving a request for access from a requestor identifying the document by the document ID or other document management information;
notifying the owner of the request for access to the document by the requestor;
receiving permission or denial from the owner in response to the request for access; and
retrieving the document for access by the requestor if permission is received from the owner.

10. A computer implemented method of managing documents, comprising:
receiving a document to be processed;
generating document management information associated with the document, the document management information including at least a document ID;
storing the processed document in association with the document management information;
at a request by a first user, generating a request to a second user to verify whether the content of the document is authentic;
receiving a verification result from the second user; and
storing the verification result and an identity of the second user in association with the document.

11. A system for processing and managing documents, comprising:
a document intake system for receiving a document to be processed and for generating document management information associated with the document, the document management information including at least a document ID;
a processing system for processing the document, including applying the document ID and a time stamp on at least some of the one or more pages of the document and converting the document to a read-only format;
a storage and archive system for storing the processed document in association with the document management information; and
a sharing system for retrieving the document based on the document management information.

12. The system of claim 11, wherein the processing system further applies a barcode on each page of the document.

13. The system of claim 11, wherein the processing system further applies a page number on each page of the document.

14. The system of claim 11, wherein the processing system further adds one or more pages at a beginning or end of the document, and applies the document ID and the time stamp on each of the added pages.

15. The system of claim 11, wherein the processing system further applies a digital certificate, digital signature or digital fingerprint to the document.

16. The system of claim 11, further comprising a referencing system for defining a reference chain linking the document with another document stored in the storage and archive system.

17. The system of claim 11, wherein the sharing system retrieves the document upon permission of an owner of the document.

18. The system of claim 17, further comprising a requesting system for retrieving the document upon request by a non-owner of the document.

19. The system of claim 11, further comprising a verification system for generating a request on behalf of a first user for verification of a document and receiving a verification result from a second user, wherein the verification result verifies that the content of the document is authentic, and wherein the storage and archive system stores the verification result and an identity of the second user in association with the document.

20. The method of claim 1, wherein the processing step includes applying the document ID and a time stamp on each page of the document.

21. The method of claim 1, wherein the processing step further includes applying a barcode on at least some of the one or more pages of the document.

22. The method of claim 1, wherein the processing step further includes applying a page number on at least some of the one or more pages of the document.

23. The method of claim 1, wherein the processing step further includes adding one or more pages at a beginning or end of the document, and applying the document ID and the time stamp on at least some of the added pages.

24. The system of claim 11, wherein the processing system applies the document ID and a time stamp on each page of the document.

25. The system of claim 11, wherein the processing system further applies a barcode on at least some of the one or more pages of the document.

26. The system of claim 11, wherein the processing system further applies a page number on at least some of the one or more pages of the document.

27. The system of claim 11, wherein the processing system further adds one or more pages at a beginning or end of the document, and applies the document ID and the time stamp on at least some of the added pages.
